(19) United States
(12) Patent Application Publication
(10) Pub. No.: US 2021/0034115 A1
(43) Pub. Date: Feb. 4, 2021

(54) SERVICEABLE DISPLAYS WITH NARROW BEZELS

(71) Applicant: Intel Corporation, Santa Clara, CA (US)

(72) Inventors: Prasanna Pichumani, Bangalore (IN); Prakash Kurma Raju, Bangalore (IN); Mikko A. Makinen, Santa Clara, CA (US); Vinay Kumar Chandrasekhara, Bangalore (IN); Juha Tapani Paavola, Hillsboro, OR (US); Seppo O. Vesamaki, Pirkanmaa (FI); Timo Herranen, Pirkanmaa (FI)

(73) Assignee: Intel Corporation, Santa Clara, CA (US)

(21) Appl. No.: 17/072,639

(22) Filed: Oct. 16, 2020

Related U.S. Application Data
(60) Provisional application No. 63/039,435, filed on Jun. 15, 2020.

(51) Int. Cl. G06F 1/16

(52) U.S. Cl. CPC G06F 1/1679; G06F 1/1654; G06F 1/1626

(57) ABSTRACT

Computing devices comprise a releasably attachable display assembly to secure a display to a device housing. The display assembly comprises a cover glass to which a display is attached. A retention frame attached to the perimeter of the cover glass comprises a plurality of hooks along one edge and a plurality of snaps along the remaining edges. The hooks and snaps engage with internal retention features along the interior of the housing to secure the display assembly to the housing. A liquid adhesive secures the cover glass to the retention frame. The display assembly further comprises an energy absorber to form a seal between the frame and the housing. The display assembly allows for computing devices with displays that are easily removable for improved serviceability and narrower bezels for improved industrial design.

### CROSS-REFERENCE TO RELATED APPLICATION

This application claims priority to, and the benefit of, U.S. Provisional Patent Application No. 63/039,435, filed on Jun. 15, 2020, which is incorporated by reference herein in its entirety.

### BACKGROUND

In some existing mobile devices, the display is held to the device housing by a pressure-sensitive adhesive (PSA). The use of a PSA to secure the display to the device can make the repair of such devices difficult as attempting to separate the display from the housing can result in breaking the display. Such devices also typically have a wider bezel due to the amount of area needed to secure the display to the device housing with a PSA. This can detract from the industrial design of the device and can limit the display size.

### BRIEF DESCRIPTION OF THE DRAWINGS

FIGS. 1A-1D illustrate cross-sectional views of computing devices employing pressure-sensitive adhesives to attach a display to a device housing.

FIG. 2A illustrates a cross-sectional view of an exemplary computing device comprising a display assembly with snaps.

FIG. 2B illustrates a cross-sectional view of an exemplary computing device comprising a display assembly with hooks.

FIG. 3A illustrates a front view of a mobile computing device.

FIG. 3B illustrates a cross-sectional view of the mobile computing device of FIG. 3A taken along the line A-A′ of FIG. 3A.

FIG. 3C illustrates a perspective view of the cross-section of FIG. 3B.

FIG. 3D illustrates a top cross-sectional view of the mobile computing device of FIG. 3A.

FIG. 4 lists various bezel dimensions and total bezel widths for the top, bottom, left, and right bezels of the computing device of FIGS. 3A-3D.

FIG. 5A illustrates a front view of a first exemplary computing device comprising a releasably attachable display assembly.

FIG. 5B illustrates a cross-sectional view of the mobile computing device of FIG. 5A taken along the line A-A′.

FIG. 5C illustrates a top cross-sectional view of a portion of the mobile computing device of FIG. 5A.

FIG. 6 lists various bezel dimensions and total bezel widths for the top, bottom, left, and right bezels of the computing device of FIGS. 5A-5C.

FIG. 7 illustrates an exploded view of a first exemplary display assembly.

FIG. 8 illustrates the engagement of a second exemplary display assembly with a smartphone housing as part of attaching the display assembly to the smartphone.

FIG. 9 illustrates a cross-sectional view of a first exemplary hook and a first exemplary snap.

FIG. 10 illustrates an exemplary collection of display assembly components.

FIG. 11 illustrates an exemplary retention frame.

FIG. 12 illustrates cross-sectional views of two computing devices with narrow bezels and a computing device with a wider bezel.

FIG. 13 is an exemplary method of attaching a display assembly to a computing device housing.

FIG. 14 is an exemplary method of separating a display assembly from a computing device housing.

FIG. 15 is a block diagram of an exemplary computing device 1300 in which technologies described herein may be implemented.

FIG. 16 is a block diagram of an exemplary processor core that can execute instructions as part of implementing technologies described herein.

### DETAILED DESCRIPTION

Laptop computers and mobile computing devices are moving towards designs with narrow display bezels to enable sleek form factors. Original equipment manufacturers, original device manufacturers, and consumers also want fully serviceable devices, particularly with respect to displays. That is, these parties desire devices with displays that are easily removable and replaceable, and that allow for easy access to the interior of the device to allow for the repair and replacement of other parts. In some existing devices, the cover glass is attached to a device housing using a pressure-sensitive adhesive (PSA). In such designs, removing the cover glass presents a challenge. The display is likely to break if removal is attempted and repair of these systems can be difficult and expensive. Devices in which PSAs are used to attach the cover glass to a device housing also typically have wide bezels due to the amount of PSA needed to meet bonding strength requirements.

In the following description, specific details are set forth, but embodiments of the technologies described herein may be practiced without these specific details. Well-known circuits, structures, and techniques have not been shown in detail to avoid obscuring an understanding of this description. “An embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. The term “coupled”, “connected”, and “associated” may indicate elements electrically, electromagnetically, and/or physically (e.g., mechanically or chemically) co-operate or interact with each other, and do not exclude the presence of intermediate elements between the coupled, connected, or associated items absent specific contrary language. Terms modified by the word “substantially” include arrangements, orientations, spacings, or positions that vary slightly from the meaning of the unmodified term.

The description may use the phrases “in an embodiment,” “in embodiments,” “in some embodiments,” and/or “in various embodiments,” each of which may refer to one or more of the same or different embodiments. Furthermore, the terms “comprising,” “including,” “having,” and the like, as used with respect to embodiments of the present disclosure, are synonymous.

Reference is now made to the drawings, wherein similar or same numbers may be used to designate the same or similar parts in different figures. The use of similar or same numbers in different figures does not mean all figures including similar or same numbers constitute a single or same embodiment. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form to facilitate a description thereof. The intention is to cover all modifications, equivalents, and alternatives within the scope of the claims.

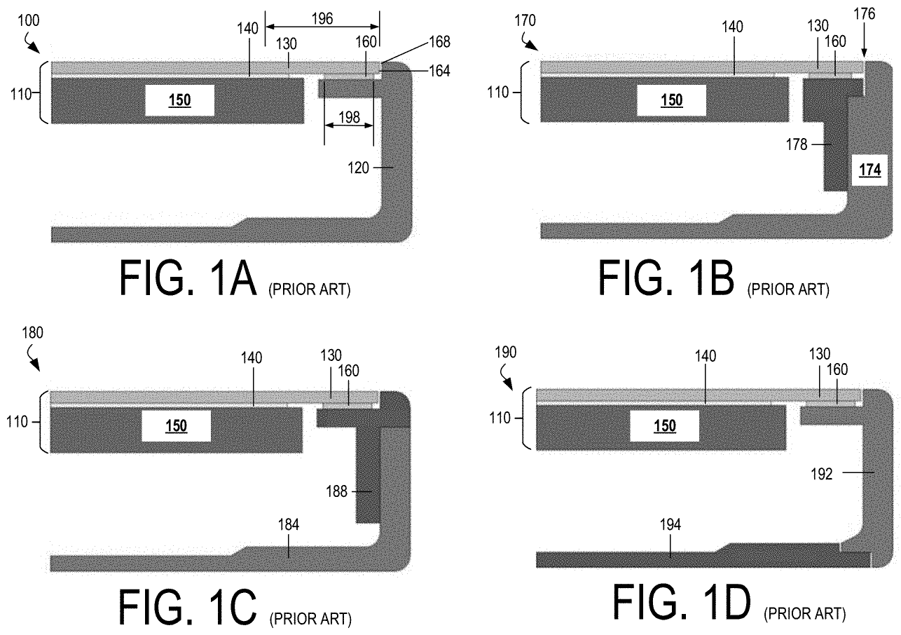

FIGS. 1A-1D illustrate cross-sectional views of computing devices employing pressure-sensitive adhesives to attach a display to a device housing. FIG. 1A illustrates a computing device 100 comprising a display assembly 110 attached to a device housing. The display assembly 110 comprises a cover glass 130, a touchscreen 140, and a display 150. The display assembly 110 is attached to the housing 120 by a pressure-sensitive adhesive 160. As an exterior edge 164 of the cover glass 130 is located immediately adjacent to an outward-facing viewable edge 168 of the device housing 120, the computing device 100 just two outward-facing components, the housing 120 and the cover glass 130, which gives the device 100 a clean, aesthetically pleasing appearance. As used herein, the term “immediately adjacent” means that the parts, components, layers, etc. described as being immediately adjacent to each other have no other parts, components, layers, etc. located between them (other than the possible exception of a small air gap). As the cover glass 130 is directly attached to the device housing 120 via the PSA 160, the device 100 is considered to have a unibody design. As the device 100 employs the PSA 160 to attach the display assembly 110 to the housing 120, repair or replace of the display assembly 110 involves delaminating the display assembly 110 from the device housing 120.

FIG. 1B illustrates a computing device 170 in which the display assembly 110 is attached to a device housing 174 via a display frame 178. The device 170 is not considered to be of unibody construction as the display assembly 110 is not directly attached to the device housing 174 (i.e., the display frame 178 connects the assembly 110 to the housing 170). The display frame 178 may be releasably attachable to the device housing 174 (by fasteners, for example), allowing for improved serviceability of the device 170 over the device 100. However, the improved serviceability comes at the expense of an additional component, the display frame 178. A gap 176 between the cover glass 130/display frame 178 and the device housing 174 makes the device 170 prone to dirt and water ingress.

FIG. 1C illustrates a computing device 180 in which the display assembly 110 is attached to a device housing 184 via a display frame 188. The device 180 is similar to the device 170 in that it is not of unibody construction and has improved serviceability if the display frame 188 is releasably attachable to the device housing 184. The device 180 differs from the devices 100 and 170 in that a portion of the display frame 188 extends to the outer surface of the device 180, which detracts from its aesthetics.

FIC. 1D illustrates a computing device 190 in which the display assembly 110 is directly attached to a device housing 192 via the PSA 160 and improved serviceability is made possible by a removable back cover 194. Again, serviceability comes at the price of an additional component (the back cover 194) separate from the device housing 192. The back cover 194 detracts from the aesthetics of the device 190 as it is an outwardly viewable component that is seen as a component separate from the device housing 194. The back cover 194 can also result in increased system thickness.

As the display assembly 110 is connected to either a device housing or a device frame via the PSA 160 in the devices illustrated in FIGS. 1A-1D, all devices have a wide bezel (e.g., dimension 196 in FIG. 1A—the distance from the edge of the cover glass to the display active area) due to the width of the PSA needed (e.g., dimension 198 in FIG. 1A) to meet bonding strength requirements to securely attach the display assembly 110 to the device housing or display frame.

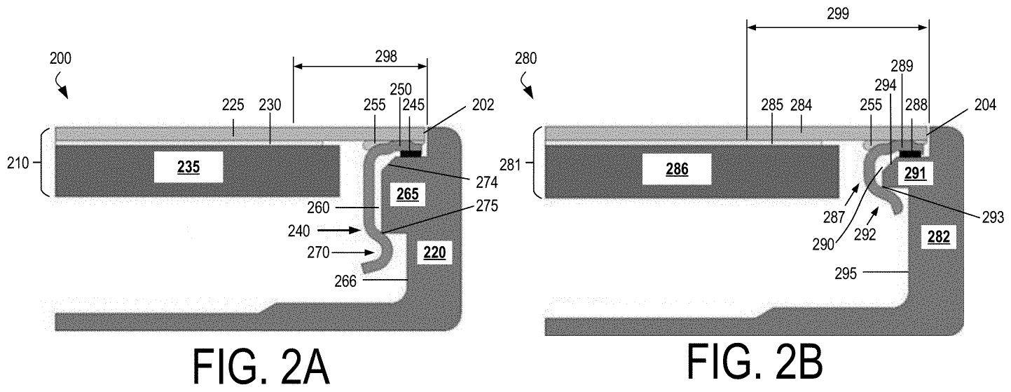

FIGS. 2A-2B illustrate cross-sectional views of exemplary retention elements for attaching a display to a device housing. FIG. 2A illustrates a cross-sectional view of an exemplary computing device comprising a display assembly with snaps. The device 200 comprises a display assembly 210 releasably attached to a device housing 220. The display assembly comprises a cover glass 225, a touchscreen 230, a display or display module 235, a retention element 240, and an energy absorber 245. The cover glass 225 comprises an exterior edge 202 that is immediately adjacent to the housing 220. The retention element 240 is a part of a retention frame 250 that extends along a perimeter of the cover glass 225. The retention frame 250 is attached to the cover glass 225 via a liquid adhesive 255. In other embodiments, a retention frame is mechanically or chemically attached to a cover glass in other manners. The device housing 220 comprises an internal retention feature 265 that extends from an internal sidewall 266 of the device 200 into a recess 260 of the internal retention element 240. The retention element 240 is a snap that has a spring effect. When the display assembly 210 is attached to the device housing 220 a snap portion 270 of the retention element 240 touches a portion 275 of the internal retention feature 265 to aid in securing the display assembly 210 to the device housing 220.

When attaching the display assembly 210 to the device housing 220, the snap 240 initially engages with the internal retention feature 265 when the snap portion 270 touches an angled edge 274 of the internal retention feature 265. The angled edge 274 displaces the snap 240 away from the device housing 220 as the display assembly 210 is pushed, tilted, or pivoted toward the device housing 200 and remains displaced for as long as the snap portion 270 moves along the internal retention feature 265 as the display assembly 210 is moved into place. Once the snap portion 270 has traveled the length of the internal retention feature 265, the spring effect of the snap 240 causes the snap portion 270 to displace back toward the device housing 220 and the internal retention feature 265 extends into the recess 260, causing the retention element 240 to become fully engaged with the housing 220.

FIG. 2B illustrates a cross-sectional view of an exemplary computing device comprising a display assembly with hooks. The device 280 comprises a display assembly 281 releasably attached to a device housing 282. The display assembly 281 comprises cover glass 284, touchscreen 285, display or display module 286, a retention element 287, and an energy absorber 288. The cover glass 284 comprises an exterior edge 204 that is immediately adjacent to the housing 220. The retention element 287 is a part of a retention frame 289 that extends along a perimeter of the display assembly 281 and can attach to the cover glass 284 in any of the manners discussed in regard to how the retention frame 250 attaches to cover glass 225 in FIG. 2A. The device housing 282 comprises an internal retention feature 291 that extends from an internal sidewall 295. The retention element 287 comprises a recess 290 into which the internal retention feature 291 extends. The retention element 287 is a hook and has a spring effect similar to that of the snap 240. When the display assembly 281 is attached to the device housing 282 a hook portion 292 of the hook 287 touches a portion 293 of the internal retention feature 291 to aid in securing the display assembly 281 to the device housing 282. The retention frames of FIGS. 2A-2B are made of metal but can be made of other materials in other embodiments.

When attaching the display assembly 281 to the device housing 282, an angled edge 294 of the internal retention feature 291 displaces the retention element 287 away from the device housing 282 as the display assembly 281 is pushed, tilted, or pivoted into place and remains displaced for as long as the hook portion 292 is touching the internal retention feature 291 as the display assembly 281 is moved in place. Once the hook portion 292 has cleared the internal retention feature 291, the spring effect of the hook 287 causes the hook portion 292 to displace back toward the device housing 282 and the internal retention feature 291 extends into the recess 290.

In some embodiments, retention elements are prestressed when assembling the display assembly, which can help ensure that the display assembly stays stiff and does not separate from a device housing when a device is dropped. The spring-attached display assemblies disclosed herein can also provide structural resilience against drops or other impact events. For example, the bezel can become deformed if a device is dropped and if the cover glass is firmly attached to the device housing, such as via a PSA, the glass may break, or the PSA may fail. In devices utilizing the spring-attached display assemblies described herein, the bezel can be narrower as the spring retention elements allow the display assembly to flex in response to bezel deformation.

In some embodiments, internal retention features can have configurations other than those shown in FIGS. 2A-2B. For example, the angled edges 274 and 294 can have different angles or an internal retention feature can have multiple angled edges. In other embodiments, the internal retention features can have different cross-sectional profiles than those of internal retention features 265 and 291, such as cross-sectional profiles that have curved edges. In other embodiments, snaps can have cross-sectional profiles different than that of snap 270 and hooks can have cross-sectional profiles that are different than that of hook 287.

The spring-attached display assemblies described herein allow for highly serviceable computing devices. A display assembly can be easily removed for repair or replacement via the application of a pulling force to the cover glass. Such a pulling force can be applied to the cover glass of a display assembly using one or more suction cups. The suction cups can be pulled directly by a user or they can be part of a suction cup opening tool pliers. For example, in a smartphone embodiment, a user can attach a suction cup to the cover glass and separate the display assembly from the smartphone by pulling on the suction cup with one hand while holding onto the smartphone housing with their other hand. A removed display assembly can be repaired or replaced and allow for access to internal computing device components for service.

In addition to providing a high level of serviceability, the display assemblies described herein can also enable bezels that are narrower than those in devices that employ a PSA to attach the cover glass to the device housing. The display assemblies 200 and 280 have bezel widths of 298 and 299, respectively. These bezel widths are narrower than the bezel width 196 in FIG. 1A as the width of the liquid adhesive 255 needed to meet bonding strength requirements is narrower than the width of the PSA 160 needed to satisfy the same requirements.

The energy absorbers 245 and 288 provide a seal between the cover glass and the device housing that protects the interior of devices 200 and 280 from dirt and water. In some embodiments, the energy absorbers 245 and 288 are compressible and absorb some of the compressive force applied by the display assembly to the device housing when the display assembly is attached to the device housing through deformation. For example, when a display assembly is attached to a device housing, an energy absorber can expand laterally in the gap between the retention frame and the device housing. In some embodiments, the energy absorber is a gasket. In some embodiments, the gasket is made of rubber or other compressible material. In some embodiments, the energy absorber is attached to the display assembly with a weak adhesive, allowing for the energy absorber to be easily removed and replaced when a display assembly is serviced. The display assemblies described herein can be used with a variety of display types, including LCDs (liquid crystal displays), OLED (organic LEDs (light-emitting diodes) displays, foldable OLEDs, and micro-LED displays.

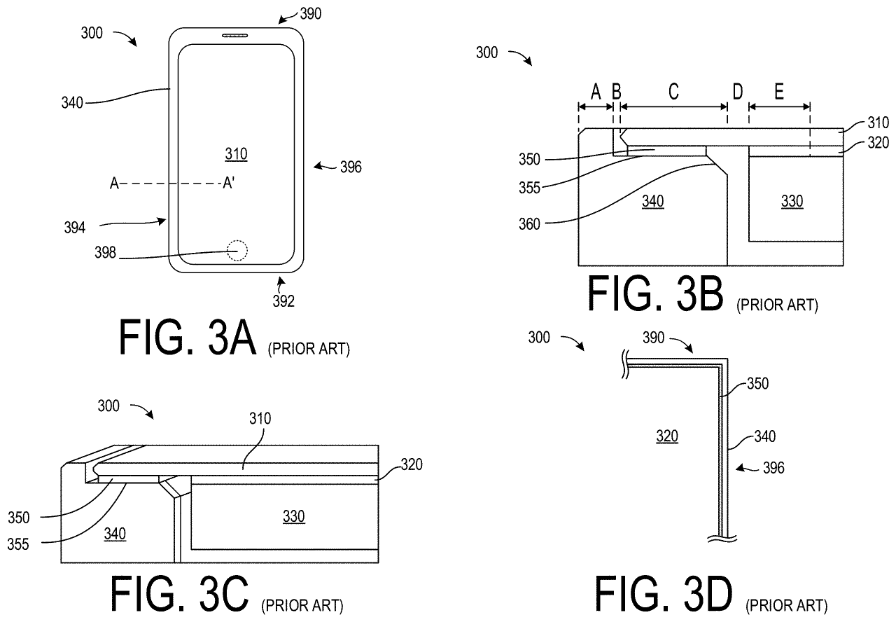

FIGS. 3A-3D illustrate various views of a computing device with a cover glass attached to the device housing via a pressure-sensitive adhesive. FIG. 3A illustrates a front view of a mobile computing device. The computing device 300 comprises a display 310 attached to a display housing 340 via a PSA 360. The computing device 300 comprises a top bezel 390, a bottom bezel 392, a left bezel 394, a right bezel 396, and an input element 398 below the cover glass. FIG. 3B illustrates a cross-sectional view of the computing device 300 taken along the line A-A′ of FIG. 3A illustrates a perspective view of the cross-sectional view of FIG. 3B. FIG. 3D illustrates a top cross-sectional view of a portion of the computing device 300. The device 300 comprises a cover glass 310, a touchscreen 320, a display 330, a housing 340, and a PSA 350 that attaches the cover glass 310 to the housing 340. The PSA 350 is a continuous strip of adhesive along the perimeter of the cover class 310, as shown in FIG. 3D

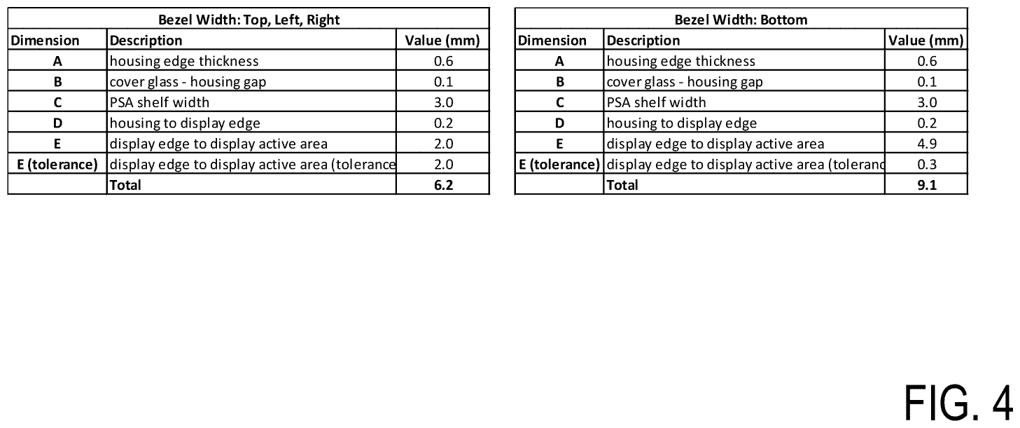

FIG. 4 lists various bezel dimensions and total bezel widths for the top bezel 390, the bottom bezel 392, the left bezel 394, and the right bezel 396 of the computing device 300. The bottom bezel width is greater than the other bezel widths as it houses the input element 398. Dimension A is the width of the housing 340 around the cover glass 310, as measured from an outer sidewall of the device housing 340 to an interior sidewall of the housing 340 immediately adjacent to the cover glass 310. For the device 300, dimension A is 0.6 mm for all four bezels. Dimension B is the width of the gap between the cover glass 310 and the housing 340. Dimension B is 0.1 mm for all four bezels. Dimension C is the width of a housing shelf 355 upon which the PSA 350 is located (including the width of an angled portion 360) and is 3.0 mm for all four bezels. Dimension D is the distance between an inner sidewall of the housing 340 and the display 330 and is 0.2 mm for all four bezels. Dimension E is the distance from the edge of the display 330 to the edge of the active area of the display. Dimension E is 2.0 mm for the top, left, and right bezels and 4.9 mm for the bottom bezel. The tolerance for dimension E is 0.3 mm for all four bezels. Adding these values together yields a bezel width of 6.2 mm for the top, left, and right bezels, and 9.1 mm for the bottom bezel for the computing device 300.

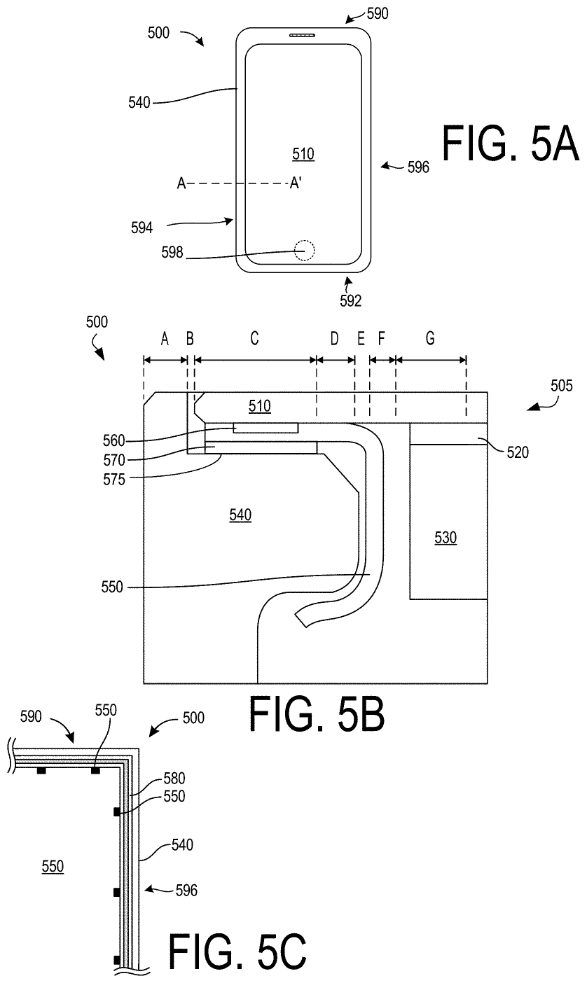

FIGS. 5A-5C illustrate various views of an exemplary computing device 500 comprising a releasably attachable display assembly. FIG. 5A illustrates a front view of the computing device 500. The computing device 500 comprises a display 510 releasably attachable to a display housing 540 via a display assembly 505. The computing device comprises a top bezel 590, a bottom bezel 592, a left bezel 594, a right bezel 596, and an input element 598 below the cover glass. FIG. 5B illustrates a cross-sectional view of the computing device 300 taken along the line A-A′ of FIG. 5A. FIG. 5C illustrates a top cross-sectional view of a portion of the computing device 500. The device 500 comprises a housing 540 and a display assembly 505. The display assembly 505 comprises a cover glass 510, a touchscreen 520, a display 530, a snap 550, and an energy absorber 570. The snap 550 attaches the display assembly 505 to the housing 540 and is attached to the cover glass 510 by a liquid adhesive bead 560. The energy absorber 570 is located between the snap 550 and the housing 540 and provides a seal between the display assembly and the housing 540. With reference to FIG. 5C, a retention frame 580 comprises multiple snaps 550. The liquid adhesive bead 560 is a continuous bead along the length of the retention frame 580.

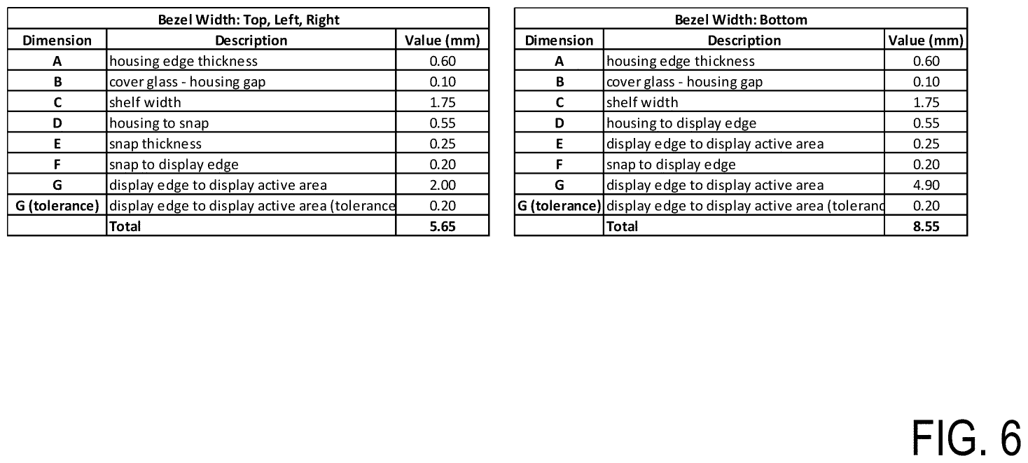

FIG. 6 lists various bezel dimensions and the total bezel widths for the top bezel 590, the bottom bezel 592, the left bezel 594, and the right bezel 596 of the device 500. Similar to the device 300, the bottom bezel for the device 500 has a greater width than the other bezels as it houses an input element. Dimensions A and B for device 500 are the same as for device 300. Dimension C is the width of a shelf 575 that the energy absorber 570 pushes against when the display assembly 505 is attached to the housing 540 and is 1.75 mm for all four bezels. Dimension D is the distance from the edge of the shelf to the snap 550 and is 0.55 mm for all four bezels. Dimension E is the thickness of the snap 550 and is 0.25 mm for all four bezels. Dimension F is the distance between the snap 550 and the display 530 and is 0.20 mm for all four bezels. Dimension G and the tolerance for dimension G for the device 500 are the same as for the device 300 for all four bezels. Adding these dimensions together for the device 500 yields a bezel width of 5.65 mm for the top, left, and right bezels, and 8.55 mm for the bottom bezel. These bezel widths are narrower than the corresponding bezel widths for device 300 by 0.55 mm on all four sides. The reduced bezels widths in device 500 can be taken advantage of by keeping the device the same size and incorporating a larger display into the device or by keeping the display the same size and reducing the overall device size.

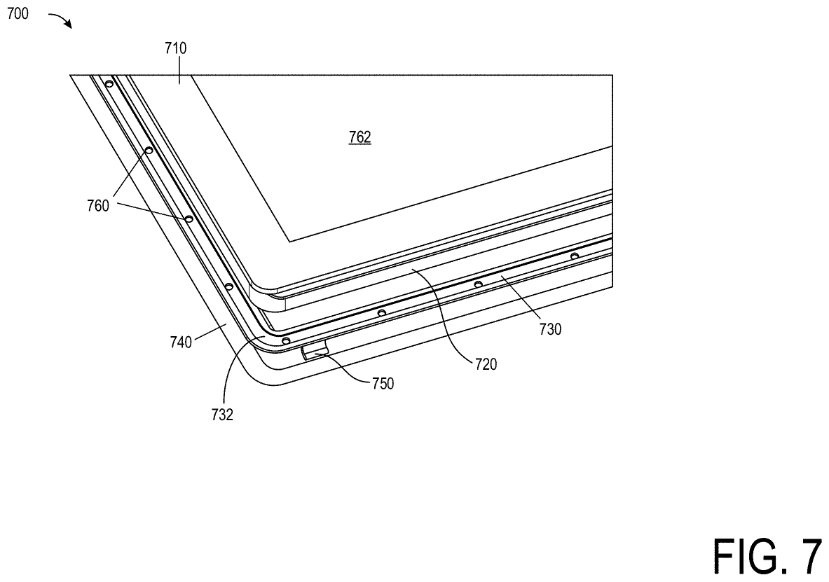

FIG. 7 illustrates an exploded view of a first exemplary display assembly. The display assembly 700 comprises a cover glass 710, a liquid adhesive bead 720, a retention frame 730, and an energy absorber 740. The retention frame 730 comprises a top edge 732, a bottom edge, and a plurality of hooks 750 (only one is shown in FIG. 7) and holes 760 to accommodate any liquid adhesive overflow that may occur during display assembly manufacture. The cover glass 710 comprises an exterior face 762 and an interior face and is attached to the top edge 732 of the retention frame 730 via the liquid adhesive bead 720. Although not shown, the display assembly 700 further comprises a display or display module comprising a display that is physically coupled to the interior face of the cover glass 710. In some embodiments, the display or display module is physically coupled to the interior face of the cover glass 710 by being directly attached to the interior face of the cover glass 710. In other embodiments, the display or display module is physically coupled to the interior face of the cover glass 710 through one or more intervening layers or components, such as a touchscreen located between the interior face of the cover glass 710 and the display or display module. The energy absorber 740 is attached to the bottom edge of the retention frame 730.

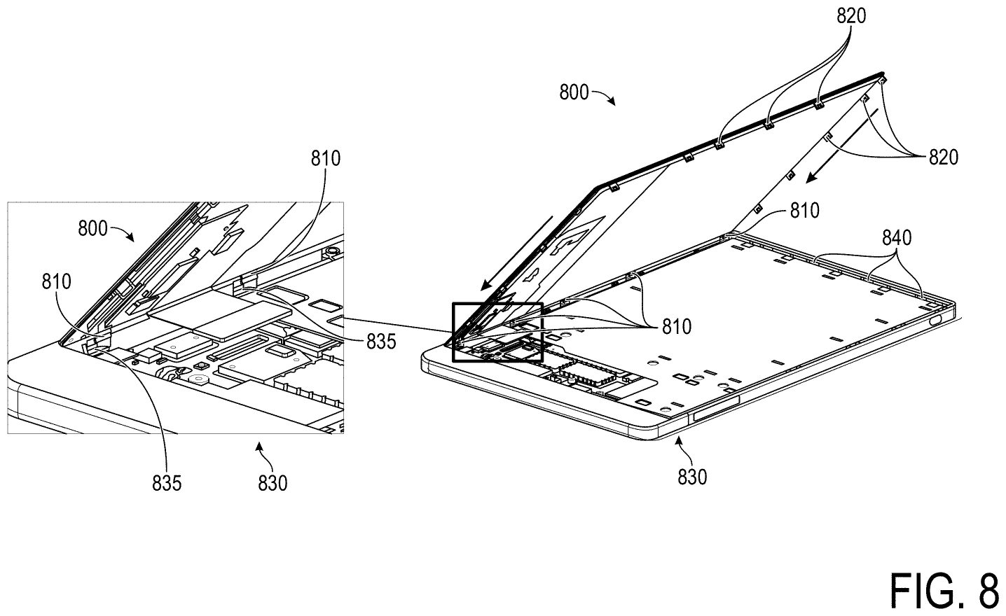

FIG. 8 illustrates the engagement of a second exemplary display assembly with a smartphone housing as part of attaching the display assembly to the smartphone. The display assembly 800 comprises a plurality of hooks 810 along one edge of the retention frame of the display assembly 800 and snaps 820 along the other three retention frame edges. To attach the display assembly 800 to a smartphone housing 830, the display assembly 800 is brought towards the housing 830 at an angle with the retention frame edge comprising the hooks 810 as the leading edge to engage the hooks 810 with corresponding internal retention features 835 in the housing 830. Once the hooks 810 are engaged, the display assembly 800 is pivoted toward the housing 830 until the snaps 820 fully engage with corresponding internal retention features 840 and the hooks 810 pivot into place about their corresponding internal retention features 835, at which point the display assembly 800 is attached to the housing 830.

Although FIG. 8 shows a display assembly in which hooks and snaps are used to attach a display assembly to a device housing, in other embodiments, a display assembly comprises retention elements that are solely snaps. Attachment of such a display assembly to a device housing comprises pressing each of the display assembly sides toward the device housing until all sides of the display assembly are snapped into place. In some embodiment, screws are used along the housing edges where snaps are used to secure the display assembly to the housing. In some embodiments, additional screws can be placed nearby connectors located in the device housing.

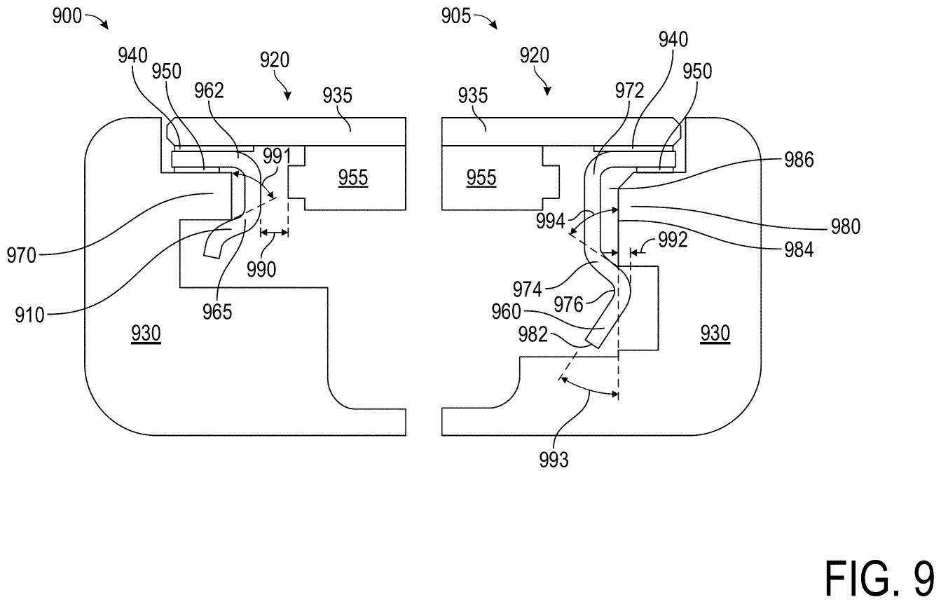

FIG. 9 illustrates a cross-sectional view of a first exemplary hook and a first exemplary snap. Cross-sections 900 and 905 illustrate a hook 910 and a snap 960 that are part of a display assembly 920 and that enable the display assembly 920 to be attached to a device housing 930. The display assembly 920 comprises a cover glass 935, an adhesive 940, the hook 910, the snap 960, an energy absorber 950, and a display 955. The hook 910 and the snap 960 are part of a retention frame that extends along the perimeter of the cover glass 935. The hook 910 has a first bend 962 and a second bend 965 that creates an angle 991 of 65 degrees between the hook 910 and an internal retention feature 970 when the display assembly 920 is fully engaged with the housing 930. A distance 990 between the hook 910 and the display 955 is 0.50 mm. The snap 960 comprises a first bend 972, a second bend 974, and a third bend 976 to create an angle 994 of 35 degrees between the snap 960 and an internal retention feature 980 and an angle 993 of 55 degrees between a snap end 982 and a vertical sidewall 984 of the internal retention feature 980. The internal retention feature 980 extends into a recess 986 of the snap by a distance 992 of 0.30 mm. In a typical computing device having a rectangular profile, the hook 910 is located along one edge of the device and the snap 920 is located on one of the three remaining edges of the device. For example, the hook 910 is located on the left side of the display assembly 920 and the snap 960 is located on either the top, bottom, or right side of the display assembly 920. In one embodiment, the hook 910 and the snap 960 of FIG. 9 can be the hooks 810 and snaps 820 of FIG. 8.

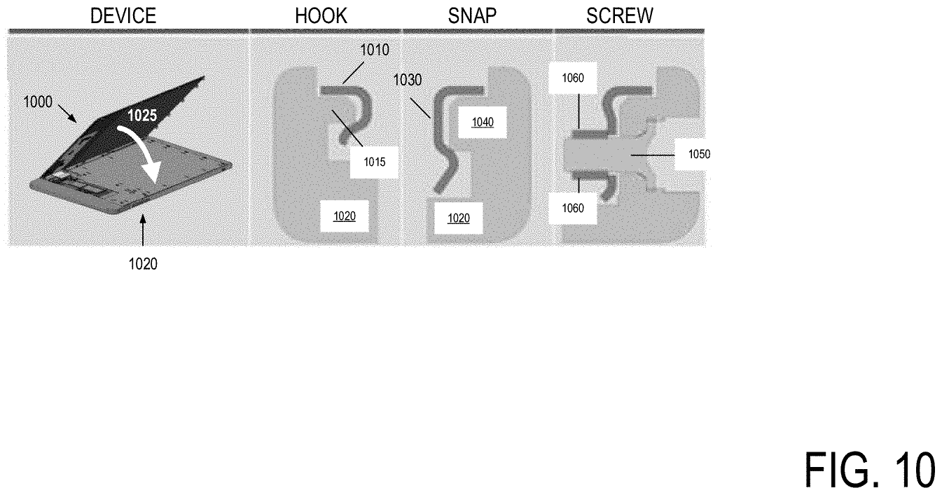

FIG. 10 illustrates an exemplary collection of display assembly components and materials. A display assembly 1000 comprises a retention frame with a plurality of hooks 1010 located along a left edge of the display assembly 1000. The display assembly 1000 is attached to a smartphone housing 1020 by engaging the hooks 1010 with internal retention features 1015 in the housing 1020 and then pivoting 1025 the display assembly 1000 about the left edge of the display assembly 1000. Snaps 1030 located along the top, bottom, and right edges engage with corresponding internal retention features 1040 located along top, bottom, and right edges of the housing 1020. The display assembly 1000 is pivoted toward the housing 1020 until the hooks 1010 and the snaps 1030 are fully engaged with their corresponding internal retention features 1015 and 1040, and the display assembly 1000 is attached to the housing 1020.

In some embodiments, to further secure the display assembly 1000 to the housing 1020 so that the display assembly 1000 does not become unintentionally separated from the housing 1020 (for example, if the device were dropped), one or more screws 1050 are utilized. The screws 1050 can be distributed along one or more edges of the housing 1020. The screws 1050 mate with counterpart screw receiving elements 1060 located in the housing 1020. In other embodiments, other fasteners and fastener receiving elements can be used to further secure a display assembly to a device housing. To remove the display assembly 1000 from the housing 1020, the screws 1050 are removed before the display assembly 1000 is pulled back from the housing 1020.

In one embodiment, the retention frame material is made of SUS 304 1/2H (i.e., 18-8 half-hard stainless steel) with a thickness of 0.30 mm. In other embodiments, the retention frame is made of a different material (e.g., SUS 301) and can have a different thickness. In one embodiment, an opening force of substantially 50N is to be applied to the cover glass to cause the snaps to disengage from the top, bottom, and right sides of the housing.

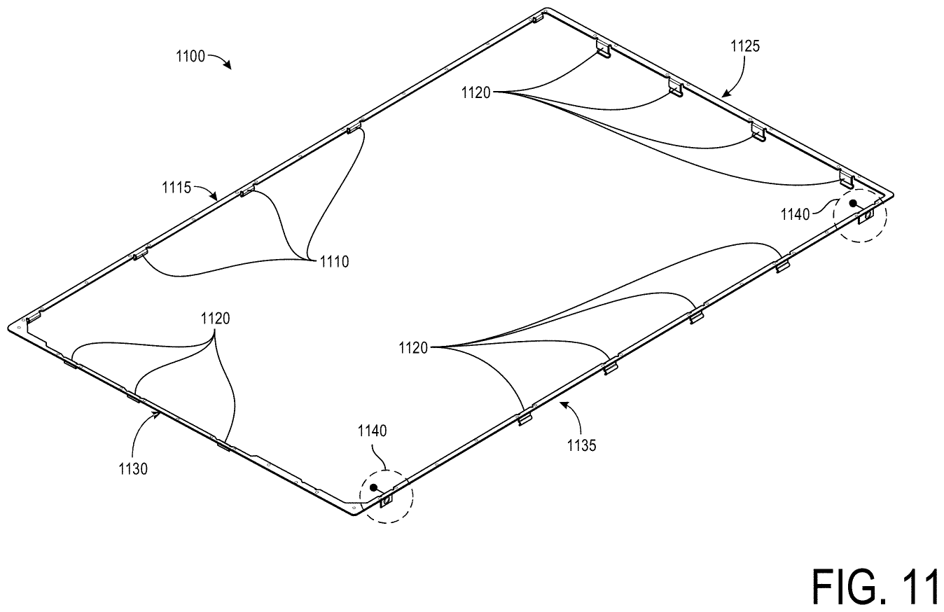

FIG. 11 illustrates an exemplary retention frame. The retention frame 1100 comprises a plurality of hooks 1110 located along a left edge 1115 of the retention frame 1100 and a plurality of snaps 1120 located along a top edge 1125, a bottom edge 1130, and a right edge 1135. The right edge 1135 comprises a pair of screw receiving elements 1140 to receive screws that aid in securing the retention frame 1100 to a device housing. In other embodiments, a retention frame can accommodate more or fewer screws than shown in FIG. 11 and a screw receiving element can be located along any retention frame edge.

In some embodiments, a display module is glued to a retention frame as follows. First, glue is dispensed into a mold to create a glue bead. Second, a retention frame is attached to the glue bead. Third, the display module is attached to the retention frame via the glue bead. Fourth, the display module is pressed against the retention frame where it is kept for an amount of time. Fifth, the combined display module-retention frame assembly (i.e., a display assembly) is held by a spring fixture for an additional amount of time to let the adhesive cure.

In some embodiments, a display assembly (comprising a cover glass and a display) can be attached to a device housing as follows. First, a housing and a display assembly are placed in an assembly jig with one edge of the display assembly attached to the housing. Second, the jig is rotated, and the display assembly snaps into place with the housing. Third, the jig opens up and releases the display assembly. Fourth, a press is used to attach the adhesive. Fifth, screws are used to secure the display assembly to the housing.

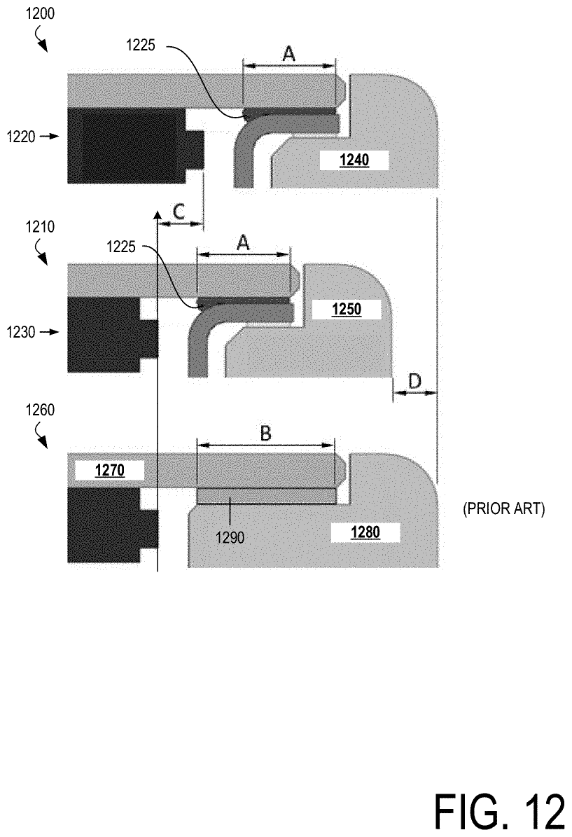

FIG. 12 illustrates cross-sectional views of two computing devices with narrow bezels and a computing device with a wider bezel. Devices 1200 and 1210 comprise display assemblies 1220 and 1230 attached to device housings 1240 and 1250, respectively. Device 1260 comprises a cover glass 1270 attached to a device housing 1280 via a PSA 1290. Dimension A is the width of a liquid adhesive 1225 and 1235 needed in the display assemblies 1220 and 1230, respectively, to meet bonding strength requirements. Dimension B is the width of the PSA 1290 needed in device 1260 to meet bonding strength requirements. As can be seen, dimension A is shorter than dimension B (due to the liquid adhesive being a stronger adhesive than the PSA), which allows for narrower bezels in devices utilizing the display assemblies described herein relative to devices using a PSA to attach a cover glass to the device housing. Narrower bezels can be utilized in different ways. In a first example, as illustrated by device 1200, a narrower bezel can enable a larger display size to be used for a given device size. Dimension C represents the amount of display size increase. In a second example, as illustrated by device 1210, a narrower bezel can enable a smaller overall device size for a given display size. Dimension D represents the amount of device size reduction enabled by a narrower bezel.

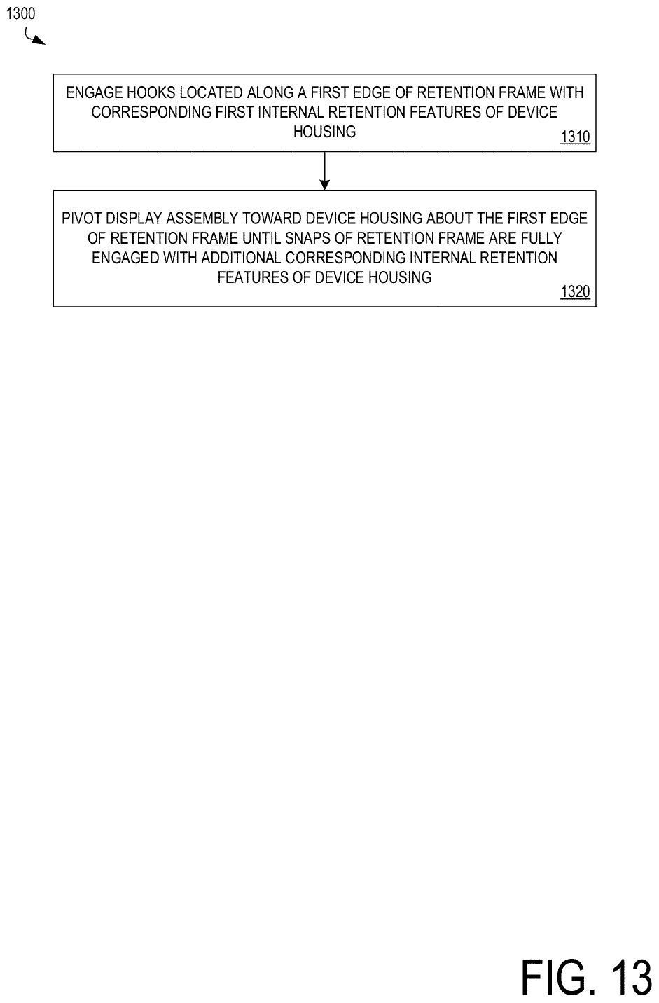

FIG. 13 is an exemplary method of attaching a display assembly to a computing device housing. The method 1300 can be performed by, for example, a computing device manufacturer as part of manufacturing or repairing a computing device. In 1310, one or more hooks located along a first edge of a retention frame of a display assembly are engaged with first corresponding internal retention features of a computing device housing. The display assembly comprises a cover glass, a display, and the retention frame. The retention frame further comprises a plurality of snaps located along one or more additional edges of the retention frame. Engaging the display assembly with the computing device housing comprises bringing the display assembly into contact with the computing device housing at an angle. In 1320, the display assembly is pivoted toward the computing device housing until the snaps are fully engaged with additional corresponding internal retention features of the computing device housing.

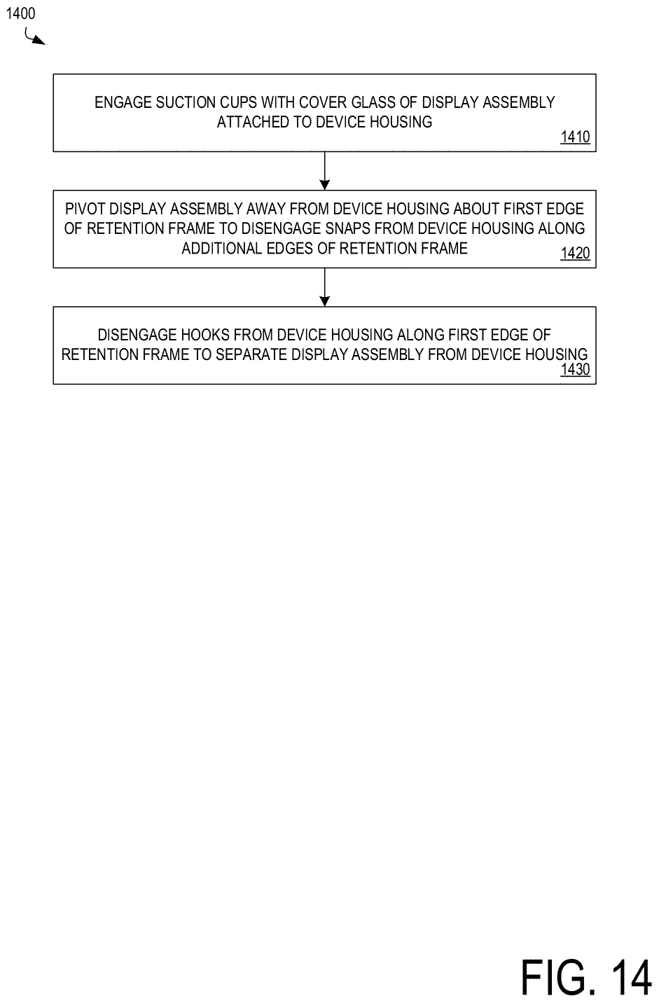

FIG. 14 is an exemplary method of separating a display assembly from a computing device housing. The method 1400 can be performed by, for example, a computing device manufacturer repairing a computing device. In 1410, one or more suction cups are engaged with a cover glass of a display assembly attached to a device. The display assembly comprises a cover glass, a display, and a retention frame. The retention frame comprises a plurality of hooks along a first edge of the retention frame and a plurality of snaps along one or more additional edges of the retention frame. The device comprises a plurality of internal retention features engaged with the hooks and the snaps. In 1420, using the suction cups, the display assembly is pivoted away from the computing device housing about the first edge of the retention frame to disengage the snaps from the computing device housing along the additional edges. In 1430, the one or more hooks are disengaged from the computing device housing along the first edge of the retention frame to separate the display assembly from the computing device housing.

Computing devices having removably attachable display assemblies as described herein have at least the following advantages. Removably attachable display assemblies allow for improved serviceability over computing devices having displays attached to the computing device housing with a pressure-sensitive adhesive. A more easily removed display assembly allows for increased ease in accessing the interior of the computing device to repair or service the computing device and increased ease in replacing the display. By not having to delaminate a display held to a housing by a PSA, it is less likely that the display will fracture upon delamination. Further, the display assemblies described herein have the advantage of being of unibody constructions (i.e., the display assemblies are attached directly to the device housing). Moreover, the display assemblies disclosed herein allow for narrower bezels. Narrower bezels can provide a more pleasing industrial design and can allow for an increased display for a given computing device size or a smaller computing device size for a given display size.

The retention frames and display assemblies described herein can be used in a wide variety of computing devices comprising a display, including mobile computing devices (e.g., smartphones, handheld computers, tablet computers, laptop computers, media players, portable gaming consoles, 2-in-1 convertible computers, portable all-in-one computers, head-mounted displays, virtual reality headsets), non-mobile computing devices (e.g., desktop computers, servers, stationary gaming consoles, set-top boxes, smart televisions, computer monitors, television sets, point-of-sale terminals, smart displays) and embedded computing devices (e.g., devices incorporated into a vehicle, home, or manufacturing equipment). The retention frames and display assemblies described herein can be used in devices with foldable displays or multiple display devices, such as dual display devices. As used herein, the term “computing device” includes computing systems and includes devices comprising multiple discrete physical components.

A computing device comprising a display assembly as described herein and capable of wireless communication with another computing device can comprise an antenna and wireless communication interface to receive information corresponding to content (text, images, videos, etc.) that is shown on the display of the display assembly. Any computing device comprising a display assembly as described herein can comprise one or more processors that cause content to be shown on a display that is part of a display assembly. For example, a computing device can comprise a graphics pipeline, the output of which drives a display. The graphics pipeline can be implemented as one or more processors such as a scaler unit and a timing control unit.

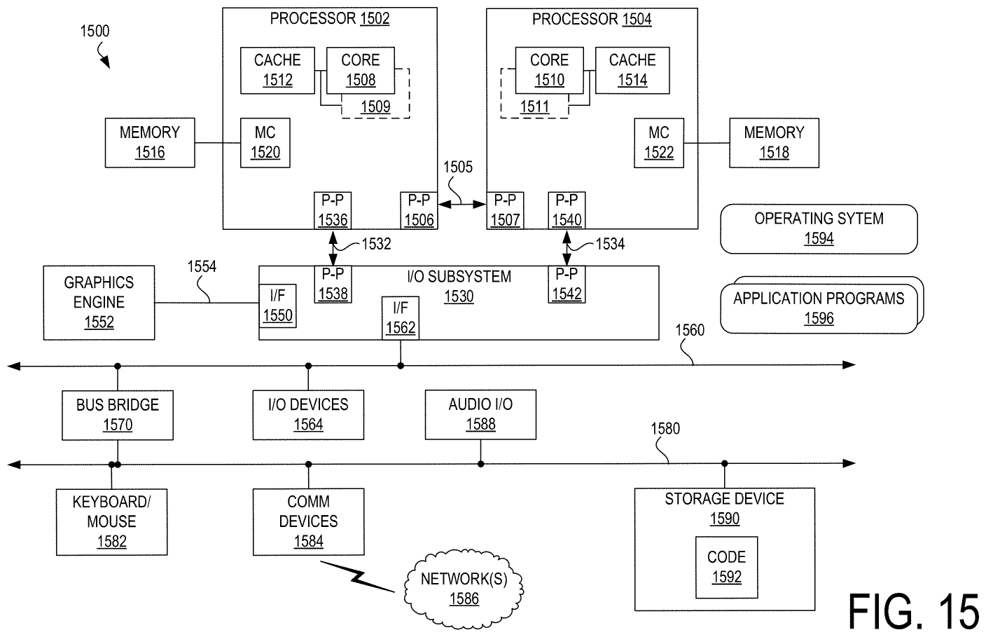

FIG. 15 is a block diagram of an exemplary computing device 1500 in which technologies described herein may be implemented. Generally, components shown in FIG. 15 can communicate with other shown components, although not all connections are shown, for ease of illustration. The device 1500 is a multiprocessor system comprising a first processor 1502 and a second processor 1504 and is illustrated as comprising point-to-point (P-P) interconnects. For example, a point-to-point (P-P) interface 1506 of the processor 1502 is coupled to a point-to-point interface 1507 of the processor 1504 via a point-to-point interconnection 1505. It is to be understood that any or all of the point-to-point interconnects illustrated in FIG. 15 can be alternatively implemented as a multi-drop bus, and that any or all buses illustrated in FIG. 15 could be replaced by point-to-point interconnects.

As shown in FIG. 15, the processors 1502 and 1504 are multicore processors. Processor 1502 comprises processor cores 1508 and 1509, and processor 1504 comprises processor cores 1510 and 1511. Processor cores 1508-1511 can execute computer-executable instructions in a manner similar to that discussed below in connection with FIG. 15, or in other manners.

Processors 1502 and 1504 further comprise at least one shared cache memory 1512 and 1514, respectively. The shared caches 1512 and 1514 can store data (e.g., instructions) utilized by one or more components of the processor, such as the processor cores 1508-1509 and 1510-1511. The shared caches 1512 and 1514 can be part of a memory hierarchy for the device 1500. For example, the shared cache 1512 can locally store data that is also stored in a memory 1516 to allow for faster access to the data by components of the processor 1502. In some embodiments, the shared caches 1512 and 1514 can comprise multiple cache layers, such as level 1 (L1), level 2 (L2), level 3 (L3), level 4 (L4), and/or other caches or cache layers, such as a last level cache (LLC).

Although the device 1500 is shown with two processors, the device 1500 can comprise any number of processors. Further, a processor can comprise any number of processor cores. A processor can take various forms such as a central processing unit, a controller, a graphics processor, an accelerator (such as a graphics accelerator, digital signal processor (DSP), or AI accelerator)). A processor in a device can be the same as or different from other processors in the device. In some embodiments, the device 1500 can comprise one or more processors that are heterogeneous or asymmetric to a first processor, accelerator, FPGA, or any other processor. There can be a variety of differences between the processing elements in a system in terms of a spectrum of metrics of merit including architectural, microarchitectural, thermal, power consumption characteristics and the like. These differences can effectively manifest themselves as asymmetry and heterogeneity amongst the processors in a system. In some embodiments, the processors 1502 and 1504 reside in the same die package.

Processors 1502 and 1504 further comprise memory controller logic (MC) 1520 and 1522. As shown in FIG. 15, MCs 1520 and 1522 control memories 1516 and 1518 coupled to the processors 1502 and 1504, respectively. The memories 1516 and 1518 can comprise various types of memories, such as volatile memory (e.g., dynamic random access memories (DRAM), static random access memory (SRAM)) or non-volatile memory (e.g., flash memory, solid-state drives, chalcogenide-based phase-change non-volatile memories). While MCs 1520 and 1522 are illustrated as being integrated into the processors 1502 and 1504, in alternative embodiments, the MCs can be logic external to a processor, and can comprise one or more layers of a memory hierarchy.

Processors 1502 and 1504 are coupled to an Input/Output (I/O) subsystem 1530 via P-P interconnections 1532 and 1534. The point-to-point interconnection 1532 connects a point-to-point interface 1536 of the processor 1502 with a point-to-point interface 1538 of the I/O subsystem 1530, and the point-to-point interconnection 1534 connects a point-to-point interface 1540 of the processor 1504 with a point-to-point interface 1542 of the I/O subsystem 1530. Input/Output subsystem 1530 further includes an interface 1550 to couple I/O subsystem 1530 to a graphics engine 1552, which can be a high-performance graphics engine. The I/O subsystem 1530 and the graphics engine 1552 are coupled via a bus 1554. Alternately, the bus 1554 could be a point-to-point interconnection.

Input/Output subsystem 1530 is further coupled to a first bus 1560 via an interface 1562. The first bus 1560 can be a Peripheral Component Interconnect (PCI) bus, a PCI Express bus, another third generation I/O interconnection bus or any other type of bus.

Various I/O devices 1564 can be coupled to the first bus 1560. A bus bridge 1570 can couple the first bus 1560 to a second bus 1580. In some embodiments, the second bus 1580 can be a low pin count (LPC) bus. Various devices can be coupled to the second bus 1580 including, for example, a keyboard/mouse 1582, audio I/O devices 1588 and a storage device 1590, such as a hard disk drive, solid-state drive or other storage device for storing computer-executable instructions (code) 1592. The code 1592 can comprise computer-executable instructions for performing technologies described herein. Additional components that can be coupled to the second bus 1580 include communication device(s) 1584, which can provide for communication between the device 1500 and one or more wired or wireless networks 1586 (e.g. Wi-Fi, cellular or satellite networks) via one or more wired or wireless communication links (e.g., wire, cable, Ethernet connection, radio-frequency (RF) channel, infrared channel, Wi-Fi channel) using one or more communication standards (e.g., IEEE 1502.11 standard and its supplements).

The device 1500 can comprise removable memory such as flash memory cards (e.g., SD (Secure Digital) cards), memory sticks, Subscriber Identity Module (SIM) cards). The memory in device 1500 (including caches 1512 and 1514, memories 1516 and 1518 and storage device 1590) can store data and/or computer-executable instructions for executing an operating system 1594 and application programs 1596. Example data includes web pages, text messages, images, sound files, or video data to be sent to and/or received from one or more network servers or other devices by the device 1500 via one or more wired or wireless networks, or for use by the device 1500. The device 1500 can also have access to external memory (not shown) such as external hard drives or cloud-based storage.

The operating system 1594 can control the allocation and usage of the components illustrated in FIG. 15 and support one or more application programs 1596. The application programs 1596 can include common mobile computing device applications (e.g., email applications, calendars, contact managers, web browsers, messaging applications) as well as other computing applications.

The device 1500 can support various input devices, such as a touchscreen, microphone, monoscopic camera, stereoscopic camera, trackball, touchpad, trackpad, mouse, keyboard, proximity sensor, light sensor, electrocardiogram (ECG) sensor, PPG (photoplethysmogram) sensor, galvanic skin response sensor, and one or more output devices, such as one or more speakers or displays. Other possible input and output devices include piezoelectric and other haptic I/O devices. Any of the input or output devices can be internal to, external to or removably attachable with the device 1500. External input and output devices can communicate with the device 1500 via wired or wireless connections.

In addition, the computing device 1500 can provide one or more natural user interfaces (NUIs). For example, the operating system 1594 or applications 1596 can comprise speech recognition logic as part of a voice user interface that allows a user to operate the device 1500 via voice commands. Further, the device 1500 can comprise input devices and logic that allows a user to interact with the device 1500 via a body, hand or face gestures.

The device 1500 can further comprise one or more communication components 1584. The components 1584 can comprise wireless communication components coupled to one or more antennas to support communication between the system 1500 and external devices. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM). In addition, the wireless modems can support communication with one or more cellular networks for data and voice communications within a single cellular network, between cellular networks, or between the mobile computing device and a public switched telephone network (PSTN).

The device 1500 can further include at least one input/output port (which can be, for example, a USB, IEEE 1594 (FireWire), Ethernet and/or RS-232 port) comprising physical connectors; a power supply (such as a rechargeable battery); a satellite navigation system receiver, such as a GPS receiver; a gyroscope; an accelerometer; a proximity sensor; and a compass. A GPS receiver can be coupled to a GPS antenna. The device 1500 can further include one or more additional antennas coupled to one or more additional receivers, transmitters and/or transceivers to enable additional functions.

It is to be understood that FIG. 15 illustrates only one exemplary computing device architecture. Computing devices based on alternative architectures can be used to implement technologies described herein. For example, instead of the processors 1502 and 1504, and the graphics engine 1552 being located on discrete integrated circuits, a computing device can comprise a SoC (system-on-a-chip) integrated circuit incorporating multiple processors, a graphics engine and additional components. Further, a computing device can connect elements via bus or point-to-point configurations different from that shown in FIG. 15. Moreover, the illustrated components in FIG. 15 are not required or all-inclusive, as shown components can be removed and other components added in alternative embodiments.

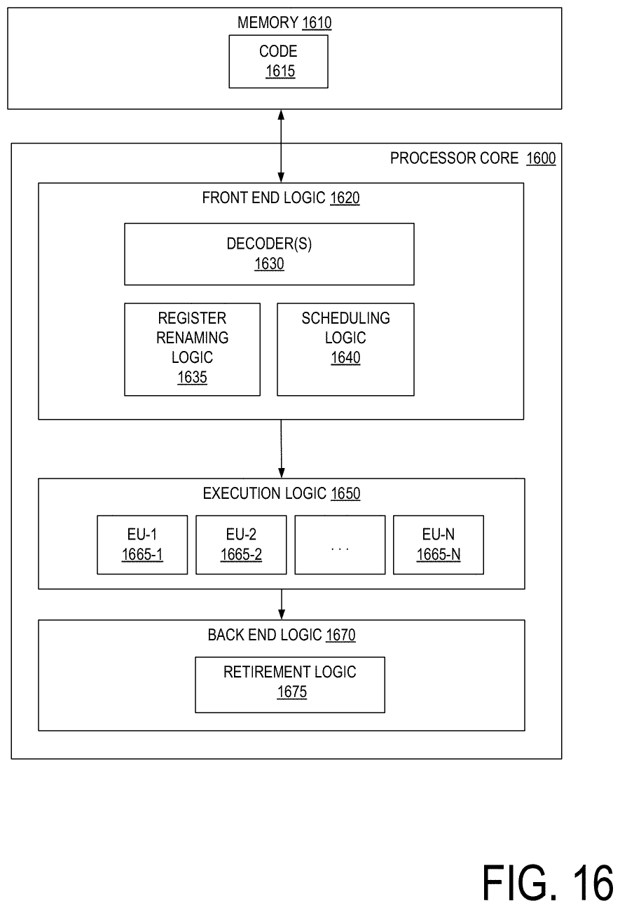

FIG. 16 is a block diagram of an exemplary processor core 1600 that can execute instructions as part of implementing technologies described herein. The processor core 1600 can be a core for any type of processor, such as a microprocessor, an embedded processor, a digital signal processor (DSP) or a network processor. The processor core 1600 can be a single-threaded core or a multithreaded core in that it may include more than one hardware thread context (or “logical processor”) per core.

FIG. 16 also illustrates a memory 1610 coupled to the processor 1600. The memory 1610 can be any memory described herein or any other memory known to those of skill in the art. The memory 1610 can store computer-executable instruction 1615 (code) executable by the processor core 1600.

The processor core comprises front-end logic 1620 that receives instructions from the memory 1610. An instruction can be processed by one or more decoders 1630. The decoder 1630 can generate as its output a micro operation such as a fixed width micro operation in a predefined format, or generate other instructions, microinstructions, or control signals, which reflect the original code instruction. The front-end logic 1620 further comprises register renaming logic 1635 and scheduling logic 1640, which generally allocate resources and queues operations corresponding to converting an instruction for execution.

The processor core 1600 further comprises execution logic 1650, which comprises one or more execution units (EUs) 1665-1 through 1665-N. Some processor core embodiments can include a number of execution units dedicated to specific functions or sets of functions. Other embodiments can include only one execution unit or one execution unit that can perform a particular function. The execution logic 1650 performs the operations specified by code instructions. After completion of execution of the operations specified by the code instructions, back-end logic 1670 retires instructions using retirement logic 1675. In some embodiments, the processor core 1600 allows out of order execution but requires in-order retirement of instructions. Retirement logic 1670 can take a variety of forms as known to those of skill in the art (e.g., re-order buffers or the like).

The processor core 1600 is transformed during execution of instructions, at least in terms of the output generated by the decoder 1630, hardware registers and tables utilized by the register renaming logic 1635, and any registers (not shown) modified by the execution logic 1650. Although not illustrated in FIG. 16, a processor can include other elements on an integrated chip with the processor core 1600. For example, a processor may include additional elements such as memory control logic, one or more graphics engines, I/O control logic and/or one or more caches.

As used in any embodiment herein, the term “module” refers to logic that may be implemented in a hardware component or device, software or firmware running on a processor, or a combination thereof, to perform one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. As used in any embodiment herein, the term “circuitry” can comprise, for example, singly or in any combination, hardwired circuitry, programmable circuitry such as computer processors comprising one or more individual instruction processing cores, state machine circuitry, and/or firmware that stores instructions executed by programmable circuitry. Modules described herein may, collectively or individually, be embodied as circuitry that forms a part of one or more devices. Thus, any of the modules can be implemented as circuitry, etc. A computer device referred to as being programmed to perform a method can be programmed to perform the method via software, hardware, firmware or combinations thereof.

Any of the disclosed methods can be implemented as computer-executable instructions or a computer program product. Such instructions can cause a computer or one or more processors capable of executing computer-executable instructions to perform any of the disclosed methods. Generally, as used herein, the term “computer” refers to any computing device or system described or mentioned herein, or any other computing device. Thus, the term “computer-executable instruction” refers to instructions that can be executed by any computing device described or mentioned herein, or any other computing device.

The computer-executable instructions or computer program products as well as any data created and used during implementation of the disclosed technologies can be stored on one or more tangible or non-transitory computer-readable storage media, such as optical media discs (e.g., DVDs, CDs), volatile memory components (e.g., DRAM, SRAM), or non-volatile memory components (e.g., flash memory, solid state drives, chalcogenide-based phase-change non-volatile memories). Computer-readable storage media can be contained in computer-readable storage devices such as solid-state drives, USB flash drives, and memory modules. Alternatively, the computer-executable instructions may be performed by specific hardware components that contain hardwired logic for performing all or a portion of disclosed methods, or by any combination of computer-readable storage media and hardware components.

The computer-executable instructions can be part of, for example, a dedicated software application or a software application that is accessed via a web browser or other software application (such as a remote computing application). Such software can be read and executed by, for example, a single computing device or in a network environment using one or more networked computers. Further, it is to be understood that the disclosed technology is not limited to any specific computer language or program. For instance, the disclosed technologies can be implemented by software written in C++, Java, Perl, Python, JavaScript, Adobe Flash, or any other suitable programming language. Likewise, the disclosed technologies are not limited to any particular computer or type of hardware.

Furthermore, any of the software-based embodiments (comprising, for example, computer-executable instructions for causing a computer to perform any of the disclosed methods) can be uploaded, downloaded or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrase “at least one of A, B or C” can mean A; B; C; A and B; A and C; B and C; or A, B and C.

The disclosed methods, apparatuses and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 is a computing device comprising: a housing; and a display assembly releasably attachable to the housing, the display assembly comprising: a cover glass; a display physically coupled to the cover glass; and a retention frame attached to the cover glass.

Example 2 is the computing device of Example 1, wherein: the housing comprises one or more internal retention features; and the retention frame comprises one or more retention elements, individual of the retention elements of the retention frame to engage with a corresponding internal retention feature of the housing when the display assembly is attached to the housing.

Example 3 is the computing device of Example 2, wherein a first retention element of the retention frame comprises a recess and a first internal retention feature of the housing extends at least partially within the recess when the display assembly is attached to the housing.

Example 4 is the computing device of Example 2, wherein a first internal retention feature comprises an angled face that causes a first retention element to be displaced away from the housing when the display assembly is inserted into the housing.

Example 5 is the computing device of Example 2, wherein at least one of the retention elements of the retention frame is a snap.

Example 6 is the computing device of Example 2, wherein at least one of the retention elements of the retention frame is a hook.

Example 7 is the computing device of Example 2, wherein the retention elements of the retention frame comprise a plurality of snaps and a plurality of hooks.

Example 8 is the computing device of Example 7, wherein the retention frame has a first edge and one or more additional edges, the plurality of snaps located along the first edge, and the plurality of hooks located along at least one of the additional edges.

Example 9 is the computing device of Example 2, wherein the retention elements of the retention frame comprise a plurality of fastener receiving elements.

Example 10 is the computing device of Example 2, wherein at least one retention element of the retention frame is to disengage from the corresponding internal retention feature of the housing when the display assembly is pulled away from the housing.

Example 11 is the computing device of Example 2, wherein at least one retention element of the retention frame is to disengage from the corresponding internal retention feature of the housing when the display assembly is pivoted away from the housing.

Example 12 is the computing device of Example 2, wherein the internal retention features of the housing extend from one or more internal sidewalls of the housing.

Example 13 is the computing device of Example 1, further comprising a touchscreen located between the cover glass and the display.

Example 14 is the computing device of Example 1, wherein the display is an OLED (organic light-emitting diode) display, a foldable OLED, a micro-LED (light-emitting diode) display, or an LCD (liquid crystal display).

Example 15 is the computing device of Example 1, wherein the display assembly further comprises an energy absorber attached to the retention frame and located between the retention frame and the housing when the display assembly is attached to the housing.

Example 16 is the computing device of Example 15, wherein the housing comprises one or more internal retention features and individual of the internal retention features comprise a shelf, the energy absorber located immediately adjacent to the shelf when the display assembly is attached to the housing.

Example 17 is the computing device of Example 1, wherein the retention frame is attached to the cover glass via an adhesive.

Example 18 is the computing device of Example 17, wherein the adhesive is a liquid adhesive.

Example 19 is the computing device of Example 1, further comprising: one or more processors; and one or more computer-readable storage media having instructions stored thereon that when executed cause the one or more processors to cause content to be shown on the display.

Example 20 is the computing device of Example 1, further comprising an antenna.

Example 21 is the computing device of Example 1, further comprising a wireless communication interface.

Example 22 is the computing device of Example 1, further comprising a battery.

Example 23 is the computing device of Example 1, further comprising a keyboard.

Example 24 is the computing device of Example 1, further comprising a timing controller unit and a scaler unit.

Example 25 is the computing device of Example 1, wherein the cover glass comprises a plurality of exterior edges, individual of the exterior edges located immediately adjacent to the housing when the display assembly is attached to the display device.

Example 26 is a display assembly comprising: a retention frame comprising a top edge, a bottom edge, and a plurality of retention elements for releasably attaching the display assembly to a housing of a computing device; a cover glass attached to the top edge of the retention frame, the cover glass comprising an interior face; a display physically coupled to the interior face of the cover glass; and an energy absorber attached to the bottom edge of the retention frame.

Example 27 is the display assembly of Example 26, wherein at least one of the retention elements comprises a recess.

Example 28 is the display assembly of Example 26, wherein at least one of the retention elements is a snap.

Example 29 is the display assembly of Example 26, wherein at least one of the retention elements is a hook.

Example 30 is the display assembly of Example 26, further comprising a touchscreen located between the interior surface of the cover glass and the display.

Example 31 is the display assembly of Example 26, further comprising one or more fastener receiving elements.

Example 32 is the display assembly of Example 26, wherein the retention frame has a first edge and one or more additional edges, wherein the plurality of retention elements comprises a plurality of snaps located along the first edge, and a plurality of hooks located along at least one of the additional edges.

Example 33 is the display assembly of Example 26, wherein the display is an OLED (organic light-emitting diode) display, a foldable OLED, a micro-LED (light-emitting diode) display, or an LCD (liquid crystal display).

Example 34 is a display assembly retention frame comprising: a top side; a bottom side; and a plurality of retention elements for releasably attaching the retention frame to a housing of a computing device.

Example 35 is the display assembly retention frame of Example 34, wherein at least one of the retention elements comprises a recess.

Example 36 is the display assembly retention frame of Example 34, wherein at least one of the retention elements is a snap.

Example 37 is the display assembly retention frame of Example 34, wherein at least one of the retention elements is a hook.

Example 38 is the display assembly retention frame of Example 34, further comprising one or more fastener receiving elements.

Example 39 is the display assembly retention frame of Example 34, wherein the retention frame has a first edge and one or more additional edges, wherein the plurality of retention elements comprises a plurality of snaps located along the first edge, and a plurality of hooks located along at least one of the additional edges.

Example 40 is a method comprising: engaging one or more hooks with one or more first corresponding internal retention features of a computing device housing, the hooks located along a first edge of a retention frame of a display assembly, the display assembly comprising a cover glass, a display, and the retention frame, the retention frame further comprising a plurality of snaps located along one or more additional edges of the retention frame, the engaging comprising bringing the display assembly into contact with the computing device housing at an angle; and pivoting the display assembly toward the computing device housing about the first edge of the retention frame until the snaps are fully engaged with additional corresponding internal retention features of the computing device housing.

Example 41 is a method comprising: engaging one or more suction cups with a cover glass of a display assembly attached to a computing device housing, the display assembly comprising a cover glass, a display, and a retention frame, the retention frame comprising a plurality of hooks along a first edge of the retention frame and a plurality of snaps along one or more additional edges of the retention frame, the computing device housing comprising a plurality of internal retention features engaged with the hooks and the snaps; pivoting, via the suction cups, the display assembly away from the computing device housing about the first edge of the retention frame to disengage the snaps from the computing device housing along the additional edges of the retention frame; and disengaging the hooks from the computing device housing along the first edge of the retention frame to separate the display assembly from the computing device housing.

Example 42 is a computing device comprising: a housing; and a display assembly releasably attachable to the housing, the display assembly comprising: a cover glass; a display physically coupled to the cover glass; and a retention means to releasably attach the display assembly to the housing.

Example 43 is the computing device of Example 42, further comprising a first attachment means to attach the retention means to the cover glass.

Example 44 is the computing device of Example 42 further comprising an absorbing energy means attached to the retention means, the absorbing energy means to provide a seal between the display assembly and the housing.

We claim:

1. A computing device comprising:
a housing; and
a display assembly releasably attachable to the housing, the display assembly comprising:
a cover glass;
a display physically coupled to the cover glass; and
a retention frame attached to the cover glass.

2. The computing device of claim 1, wherein:
the housing comprises one or more internal retention features; and
the retention frame comprises one or more retention elements, individual of the retention elements of the retention frame to engage with a corresponding internal retention feature of the housing when the display assembly is attached to the housing.

3. The computing device of claim 2, wherein a first retention element of the retention frame comprises a recess and a first internal retention feature of the housing extends at least partially within the recess when the display assembly is attached to the housing.

4. The computing device of claim 2, wherein a first internal retention feature comprises an angled face that causes a first retention element to be displaced away from the housing when the display assembly is inserted into the housing.

5. The computing device of claim 2, wherein at least one of the retention elements of the retention frame is a snap.

6. The computing device of claim 2, wherein at least one of the retention elements of the retention frame is a hook.

7. The computing device of claim 2, wherein the retention elements of the retention frame comprise a plurality of snaps and a plurality of hooks.

8. The computing device of claim 7, wherein the retention frame has a first edge and one or more additional edges, the plurality of snaps located along the first edge, and the plurality of hooks located along at least one of the additional edges.

9. The computing device of claim 2, wherein the retention elements of the retention frame comprise a plurality of fastener receiving elements.

10. The computing device of claim 2, wherein at least one retention element of the retention frame is to disengage from the corresponding internal retention feature of the housing when the display assembly is pulled away from the housing.

11. The computing device of claim 2, wherein at least one retention element of the retention frame is to disengage from the corresponding internal retention feature of the housing when the display assembly is pivoted away from the housing.

12. The computing device of claim 2, wherein the internal retention features of the housing extend from one or more internal sidewalls of the housing.

13. The computing device of claim 1, further comprising a touchscreen located between the cover glass and the display.

14. The computing device of claim 1, wherein the display is an OLED (organic light-emitting diode) display, a foldable OLED, a micro-LED (light-emitting diode) display, or an LCD (liquid crystal display).

15. The computing device of claim 1, wherein the display assembly further comprises an energy absorber attached to the retention frame and located between the retention frame and the housing when the display assembly is attached to the housing.

16. The computing device of claim 15, wherein the housing comprises one or more internal retention features and individual of the internal retention features comprise a shelf, the energy absorber located immediately adjacent to the shelf when the display assembly is attached to the housing.

17. The computing device of claim 1, further comprising:
one or more processors; and
one or more computer-readable storage media having instructions stored thereon that when executed cause the one or more processors to cause content to be shown on the display.

18. The computing device of claim 1, further comprising a battery.

19. The computing device of claim 1, wherein the cover glass comprises a plurality of exterior edges, individual of the exterior edges located immediately adjacent to the housing when the display assembly is attached to the display device.

20. A display assembly comprising:
a retention frame comprising a top edge, a bottom edge, and a plurality of retention elements for releasably attaching the display assembly to a housing of a computing device;
a cover glass attached to the top edge of the retention frame, the cover glass comprising an interior face;
a display physically coupled to the interior face of the cover glass; and
an energy absorber attached to the bottom edge of the retention frame.

21. The display assembly of claim 20, wherein the retention frame has a first edge and one or more additional edges, wherein the plurality of retention elements comprises a plurality of snaps located along the first edge, and a plurality of hooks located along at least one of the additional edges.

22. A display assembly retention frame comprising:
a top side;
a bottom side; and
a plurality of retention elements for releasably attaching the retention frame to a housing of a computing device.

23. The display assembly retention frame of claim 22, wherein the retention frame has a first edge and one or more additional edges, wherein the plurality of retention elements comprises a plurality of snaps located along the first edge, and a plurality of hooks located along at least one of the additional edges.

24. A computing device comprising:
a housing; and
a display assembly releasably attachable to the housing, the display assembly comprising:
a cover glass;
a display physically coupled to the cover glass; and
a retention means to releasably attach the display assembly to the housing.

25. The computing device of claim 24 further comprising an absorbing energy means attached to the retention means, the absorbing energy means to provide a seal between the display assembly and the housing.
